(19) United States
(12) Patent Application Publication
(10) Pub. No.: US 2022/0180256 A1
(43) Pub. Date: Jun. 9, 2022

(54) FORECASTING MODEL ACCURACY DATE IDENTIFICATION

(71) Applicant: Hewlett-Packard Development Company, L.P., Spring, TX (US)

(72) Inventors: Abhisarika Verma ., Pune (IN); Abhishek Ghosh, Spring, TX (US); Sandip Brahmachary, Pune (IN)

(21) Appl. No.: 17/544,728

(22) Filed: Dec. 7, 2021

(30) Foreign Application Priority Data
Dec. 7, 2020 (IN) 202041053219

(51) Int. Cl. G06Q 10/04; G06F 16/22; G06Q 10/06

(52) U.S. Cl. CPC G06Q 10/04; G06Q 30/0202; G06Q 10/0639; G06F 16/2228

(57) ABSTRACT

In an example in accordance with the present disclosure, a system is described. The system includes a database. The data base includes 1) forecasted values of an event indexed by date and 2) actual values of the event indexed by date. The system also includes a non-transitory machine-readable storage medium to store instructions. The system also includes a processor to execute the instructions. The instructions to cause the processor to determine, from a current date and based on a forecasting frequency and forecasting category for forecasted values, previous dates for which there is both a forecasted value and an actual value. The instructions also cause the processor to identify those previous dates for which there is both an actual value and a forecasted value as dates by which a forecasting model accuracy is to be determined.

### BACKGROUND

Forecasting refers to an operation wherein some future event is predicted or estimated. For example, a forecasting model may be used to determine, based on historical data, a future value for the data.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a system for selecting dates to determine forecasting model accuracy, according to an example of the principles described herein.

FIG. 2 is a flowchart of a method for selecting dates to determine forecasting model accuracy, according to an example of the principles described herein.

FIG. 3 is a flowchart of a method for selecting dates to determine forecasting model accuracy, according to an example of the principles described herein.

FIGS. 4A and 4B depict various forecasting runs used to select dates to determine forecasting model accuracy, according to an example of the principles described herein.

FIG. 5 depicts a non-transitory machine-readable storage medium for selecting dates to determine forecasting model accuracy, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Forecasting is used in many aspects of modern society. For example, business and other entities conduct their operations based on forecasted events. Accordingly, these businesses and other entities are interested in getting accurate forecasted insights on various aspects including sales, revenue, profits, and stock keeping units, among others, in order to better plan and manage their business in advance and take certain sustainable actions. As so much of their operations are dependent upon this forecasted data, it may be desirable that forecasted values and the models that generate the forecasted values be as accurate as possible with deviations between predicted values and actual values being as low as possible.

Accordingly, the present specification describes systems and methods for determining the accuracy of a forecasting model. That is, once a forecasted value is determined, the next operation is to determine if the forecasted value is accurate. For example, if a forecasting model predicted a certain number of sales on a date in the future, an accuracy of the forecasting model may be determined by, when the forecasted date arrives, comparing the forecasted number of sales for that date with the actual number of sales that occurred on that date.

In other words, to calculatean accuracy and/or deviation of a forecasting model, a previous forecasted value is found. For example, on Jan. 1, 2020, a forecasting job may be run which generates a value to be expected on Jan. 1, 2021. On Jan. 1, 2021 or later, an actual value associated with the event is determined. Accordingly, on Jan. 1,2021, a forecasting model accuracy may be determined. In this example, a simple one-year forecast deviation has been considered. However, for each particular forecasting job, data may be forecast for many different future ranges. For example, for a given forecasting run, forecasts may be made for 7 days in the future, 30 days in the future, 60 days in the future, 90 days in the future, and 180 days in the future. With various points of forecasting such as in n weeks, days, or months, it is more complex to identify and compare forecasted values with actual values for the forecasted event. That is, not every date between when the forecasting job is run and a current date may have forecasted values. Accordingly, the present specification describes systems and methods for identifying those dates for which there exists previously forecasted data.

Specifically, the present specification identifies previous dates for which there is a forecasted value. The present specification does so by identification of a pattern by which it is determined those previous dates which were part of a previously executed forecasted run and for which there is forecasted data. This pattern may be stored in a library and usable to identify dates for which there is forecasted value.

The present specification therefore includes a library operation that can identify exact previously forecasted dates in weekly or daily forecasting processes, which previously forecasted dates, and their associated values, are used to calculate deviation and accuracy of the forecasting model. The library may be reusable in a variety of subsequent applications.

In general, the present specification describes a system and a method for determining previously forecasted dates. The system may include a library that identifies a relationship between a current run date and those dates for which forecasted data is available. Once forecasted dates are determined relative to the current date, a forecasting model deviation is determined by calculating differences between previously forecasted values and actual values. Further, accuracy of the forecasting model may be estimated based on the determined deviation.

The present systems and methods identify a complex pattern that occurs between forecasted and forecasting dates on weekly, bi-weekly, monthly, etc. These patterns and relations between forecasting dates and previously forecasted dates is generalized (for weeks, bi-weeks, months etc.), deduced and formulated to identify specific dates for which previously forecasted information is available. The system may include a library that may be made available for reuse in various other forecasting applications in order to seamlessly calculate deviation and accuracy of forecasting models.

Specifically, the present specification describes a system. The system includes a database that includes 1) forecasted values of an event indexed by date and 2) actual values of the event indexed by date. The system also includes a non-transitory machine-readable storage medium to store instructions. The system also includes a processor to execute the instructions. The instructions cause the processor to determine, from a current date and based on a forecasting frequency and forecasting category for forecasted values, previous dates for which there is both a forecasted value and an actual value. The instructions also cause the processor to identify those previous dates for which there is both an actual value and a forecasted value as dates by which a forecasting model accuracy is to be determined.

The present specification also describes a method. According to the method, previous dates for which there is actual value for an event is determined based on a current date, Based on a forecasting frequency, previous dates are identified that were part of a previous forecasting run and for which there is a forecasted value for the event. Those previous dates for which there is 1) an actual value and 2) a forecasted value is identified as dates by which forecasting model accuracy is to be determined.

The present specification also describes a non-transitory machine-readable storage medium encoded with instructions executable by a processor. The machine-readable storage medium includes instructions to, when executed by the processor cause the processor to determine, from a current date, previous dates for which there is an actual value for an event. The instructions, when executed by the processor, also cause the processor to identify, as a backdate from the current date and based on a forecasting frequency, backdates 1) that were part of a previous forecasting run and 2) for which there is a forecasted value. The instructions, when executed by the processor, also cause the processor to identify, based on the current date and the backdate, previous dates for which there is both a forecasted value and an actual value. The instructions, when executed by the processor, also cause the processor to identify those previous dates for which there is both a forecasted value and an actual value as dates by which forecasting model accuracy is to be determined.

In summary, using such a system, method, and machine-readable storage medium may, for example, 1) accurately determine which dates and associated values may be used to determine an accuracy of a forecasting model; 2) provide for the reusability of the method to derive exact previous forecast dates for the calculation of deviation and accuracy in any forecasting model; 3) eliminate manual data analysis; and 4) be highly customizable. However, it is contemplated that the devices disclosed herein may address other matters and deficiencies in a number of technical areas, for example.

As used in the present specification and in the appended claims, the term “backdate” refers to a reverse chronological day count from a particular date. For example, a backdate from a current run date is an integer value representing a count of days previous from the current run date. As a specific example, a backdate of three from August 24 would be August 21 as August 21 is three days before August 24.

As used in the present specification and in the appended claims, the term “a number of” or similar language is meant to be understood broadly as any positive number including 1 to infinity.

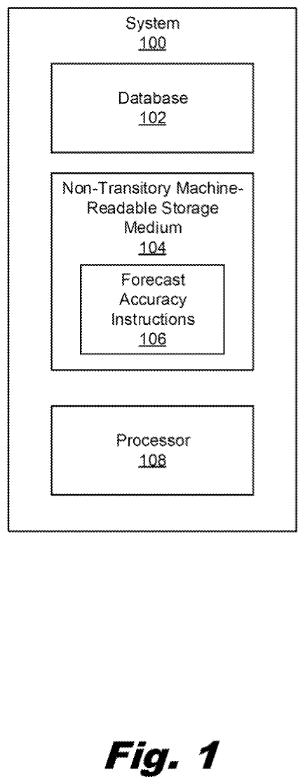

Turning now to the figures, FIG. 1 is a block diagram of a system (100) for selecting dates to determine forecasting model accuracy, according to an example of the principles described herein. As described above, forecasting refers to an operation where the occurrence of some future event is predicted. As a particular example, a manufacturer may predict how many failures of a particular component they expect to occur on a particular date. This forecasted value may be used in any number of ways. For example, the manufacturer may use this forecasted value to drive manufacturing of new components to replace failed components and/or and to drive the stock of raw materials such that the manufacturer may create additional components to replace the failed components. Given that so much is dependent upon these forecasted values, a manufacturer may desire that the forecasted value is as accurate as possible. The present system (100) identifies various dates for which there is 1) a forecasted value and 2) an actual value such that an accurate measure for forecast model accuracy may be determined. Based on the output of the system (100), changes to the forecasting model may be made.

Accordingly, the system (100) includes a database (102), The database (102) may include a physical memory device and a processor to write data to, and read data from, the physical memory device. The database (102) may include various pieces of data such as forecasted values of an event indexed by date and actual values of the event indexed by date.

A forecast job may refer to the forecasting of an event at various future time periods. For example, on Feb. 22, 2020, a forecast job may be run which forecasts a value for an event at multiple time periods Specifically, on this date, a forecasting model may forecast values associated with seven days in the future (Feb. 28, 2020), 30 days in the future (Mar. 23, 2020), 60 days in the future (Apr. 22, 2020), 90 days in the future (May 22, 2020), and 180 days in the future (Aug. 20, 2020), Each of these forecasted values may be stored in the database (102) along with the dates associated with each forecasted date. Table (1) below provides an example of the forecasted date as well as the forecasted value associated with each date.

TABLE 1

| Forecasted Date | Forecasted Value |
|---|---|
| Feb. 28, 2020 | 1 |
| Mar. 23, 2020 | 2 |
| Apr. 22, 2020 | 1 |
| May 22, 2020 | 3 |
| Aug. 20, 2020 | 4 |

In an example, each of the forecasted dates and forecasted values may further be indexed by forecasting category. As used in the present specification, the forecasting category refers to a specific time-period in the future for which the forecast is made. Examples of forecasting categories include a 7-day forecasting category, a 30-day forecasting category, a 60-day forecasting category, a 90-day forecasting category, and a 180-day forecasting category. By comparison, as used in the present specification, the forecasting frequency refers to the frequency with which forecasts are made. For example, forecasts run on February 15 and February 22 may have a forecasting frequency of one week.

Returning to the example above, the forecasted value associated with Feb. 28, 2020 may be associated with the 7-day forecasting category, the forecasted value associated with Mar. 23, 2020 may be associated with the 30-day forecasting category, the forecasted value associated with Apr. 22, 2020 may be associated with the 60-day forecasting category, the forecasted value associated with May 22, 2020 may be associated with the 90-day forecasting category, and the forecasted value associated with Aug. 20, 2020 may be associated with the 180-day forecasting category. While particular reference is made to particular categories, different forecasting categories may be implemented in accordance with the principles described herein. As described above, it may be the case that not every date has a forecasted value associated with it. Accordingly, the present specification describes the identification of those dates that have associated forecasted values such that the forecasting model accuracy may be measured.

The database (102) may also include actual values of the event indexed by date. That is, once a particular date arrives, actual values for the event is stored in the database (102). As a particular example, if component failure is the event that has been tracked and forecasted, the number of component failures is recorded daily. This information also may be indexed by date.

The system (100) may also include a non-transitory machine-readable storage medium (104) to store forecast accuracy instructions (106). The instructions (106) cause the processor (108) to execute certain operations. For example, the instructions (106) may cause the processor (108) to determine, from a current date and based on a forecasting frequency and the forecasting category for forecasted values, previous dates for which there is both a forecasted value and an actual value. That is, it may be the case that forecasted values are not available for each day in a history. For example, as depicted above, for a Feb. 22, 2020 forecast job, forecasted values are available for Feb. 28, 2020; Mar. 23, 2020; Apr. 22, 2020; May 22, 2020; and Aug. 20, 2020. The previous dates for which forecasted values are available are dependent upon 1) the forecasting frequency, that is, the interval between forecasting runs and 2) the forecasting categories, that is, the time ranges for which a forecast is made during a forecasting run. Using these two values, 1) forecasting frequency and 2) forecasting category, the system (100) may determine for which dates a previously forecasted value exists.

As described above, the determination of which dates have forecasted values associated with them is dependent upon the forecasting frequency and forecasting category. In some examples, this may be received via user input. For example, a user may input which category (i.e., 7-day, 30-day, 60-day, etc.) they would like an indication regarding a previous date for which there is a forecasted value.

The system may also determine for which previous dates actual event data exists. In general, this may be any day before the current date. Using this information, the instructions (106) may cause the processor (108) to identify those previous dates for which there is both 1) an actual value and 2) a forecasted value. Dates for which both pieces of information are available may be used to determine a forecasting model accuracy.

With the previous dates identified that are associated with both a forecasted value and an actual value, the system (100) may include instructions (106) to cause the processor to update the forecasting model based on a deviation between the actual value and the forecasted value. Updating the forecasting model may include retraining an existing machine learning model or selecting a new machine learning model. For example, if accuracy is below a threshold over multiple iterations of training and testing, a different machine learning model may be implemented and tested to determine if it results in forecasts that are more accurate and that have a lower deviation.

A specific example is now provided. In this example, a supply chain team may be determining whether to increase or decrease battery and hard-disk inventory in a service center based on a forecasted number of incidents for each part at each supply chain location. A weekly supply chain forecasting job may forecast battery replacement and hard-disk replacement by forecasting the number of incident(s) that would be created on a 7th day, a 30th day, a 60th day, a 90th day and a 180th day from the date of the forecasting job. This information may be helpful in determining the number of batteries and hard-disks to maintain in stock.

On any given run date, the system (100) may fetch previously forecasted values for each of a 7-day category, 30-day category, 60-day category, 90-day category, and 180-day category since the last run date. More specifically, the system may identify dates between adjacent run dates for which there is forecasted data available. For example, for a weekly executed forecasting job, the system (100) may identify dates within the seven days preceding a current run date for which there is forecasted data available, that is days for which forecasted values had previously been made. Those dates for which there is forecasted data available may be based on the category of the forecast, with one date in the last seven days originating from each of the forecast categories. The system (100) may identify dates between adjacent forecasting runs from each of the forecasting categories (e.g., a 7, 30, 60, 90, and 180 day forecasted date) and may retrieve the associated forecast values. Accordingly, if there are five forecasting categories (i.e., 7-day, 30-day, 60-day, 80-day, 180-day), the system (100) may identify the five specific dates from among dates immediately preceding the current run date for which there is forecasting values. The system (100) may then calculate a difference between actual current count of incidents for the component and previous forecasted values of incidents to determine whether a forecasting model is accurate.

As such, the system (100) accepts a forecasting frequency and category. For example, if a user wants to identify the previous forecasted value date for a r day forecast, the user may input a “w” and “1” to denote a 7^{th} day previous forecast category. The system (100) may return the number of days (integer values) that is to be subtracted from the current run date. This integer value indicates the date within the 7-day forecast category, for′ which a forecast of the event was previously made.

Similarly, if a user wants to identify the previous forecasted value date for a 30^{th} day forecast, the user may input a “m” and “1” to denote a 30^{th} day previous forecast category. The system (100) may return the number of days (integer values) that is to be subtracted from the current run date.

As yet another example, if a user wants to identify the previous forecasted value date for a 60^{th} day forecast, the user may input a “m” and “2” to denote a 60^{th} day previous forecast category. The system (100) may return the number of days (integer values) that is to be subtracted from the current run date. Similar inputs may be used to identify other forecasting categories for which a previous date is desired.

The operation of the system (100) may depend on the application. For example, if the user is calculating accuracy and deviation of a forecasting process for just the 30^{th} day forecast, they may input “m” and “1”.

During forecasting job execution, the forecasted values are stored in a database (102) on a storage medium, either local or remote. The system (100), using the operations described above, may return an integer value which the user is to subtract from the current run date. For example, a current run date may be August 24. To calculate an accuracy of a forecasting model that makes a 7^{th}-day forecast, a user may enter “w” and “1” into a user interface. The system (100) may return the integer value 1. In this example, the user would subtract 1 from the current date, i.e., August 24−1=August 23. Using this date of August 23, the user may go back to the database (102) and lookup a forecasted value associated with August 23.

As described above, forecasting has a frequency, That is, any forecasting job is associated with some unit of time. As described above, some forecasting jobs perform forecasting on multiple frequencies. That is, a forecasting job may use historical data points to plot forecasts for coming 7^{th} day, or 30^{th} day or 60^{th} day and so on, Complexity arises when, in the future date when actual, and not forecasted data, is available, a developer is to fetch previously forecasted data and compare the forecasted data with the actual data that is available. The system (100) as described herein calculates the accuracy for such forecasting jobs and handles relying on the multi-forecasting frequency (7, 30, 60 so on) through implementation of our invented formula.

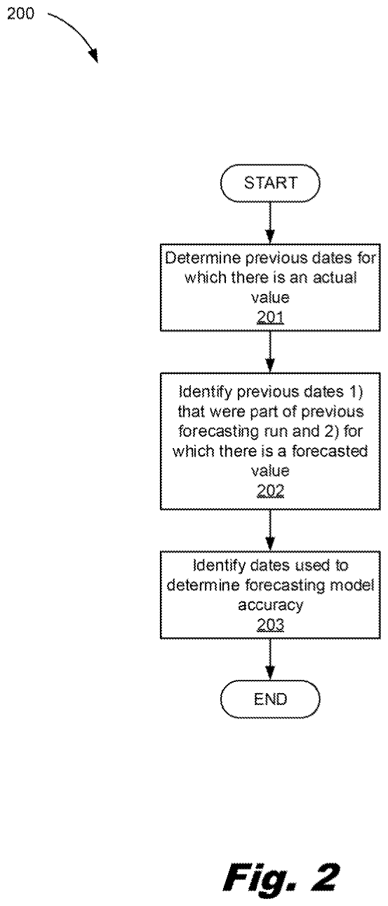

FIG. 2 is a flowchart of a method (200) for selecting dates to determine forecasting model accuracy, according to an example of the principles described herein. The method (200) includes determining (block 2010), from a current date, previous dates for which there is an actual value associated with the event. In an example, these previous dates for which there is an actual value may be any date prior to the current date. For example, during the course of operations, a business or entity may collect data relating to different events that occur. As a particular example, a business may track daily sales.

According to the method (200), previous dates that 1) were part of a previous forecasting run and 2) for which there is a forecasted value are identified (block 202). This may be based on the forecasting frequency and forecasting category. For example, a user may indicate an intent to identify a previous date that was a 7^{th}-day forecast in a previous run.

As a particular example, for a weekly forecast and for a forecasting job run on February 22, the developer may desire to know for which dates between February 15 and February 21 there are forecasted values available, as not all dates within this range may have forecasted values available. Accordingly, a user may input a forecasting category, i.e., 7^{th}-day forecasts. Based on this information, the system (FIG. 1, 100) may determine for which days between February 15 and February 21, values were forecasted during a previously run 7^{th}-day forecast. In some examples, this may include identifying the previous dates as backdates and determining the previous date based on the current date and the backdate. For example, the system (FIG. 1, 100) may output the integer value “1” indicating that the date between February 15 and February 21 for which there is 7^{th}-day forecast data available is one day behind the current run date. The system (FIG. 1, 100) may then determine from the current date, February 22, and the backdate, 1, that there is forecasted data available for February 21. Similar operations may be carried out for each of the other forecasting categories.

In this example, February 21 has an actual value based on being a date in the past and also has a forecasted value based on the system (FIG. 1, 100) determining such. As it has both an actual value and a forecasted value, February 21 therefore represents a date that may be used to determine a forecasting model accuracy. In other words, according to the method (200), those previous dates for which there is an actual value and a forecasted value are identified (block 203) as dates by which the forecasting model accuracy is to be determined.

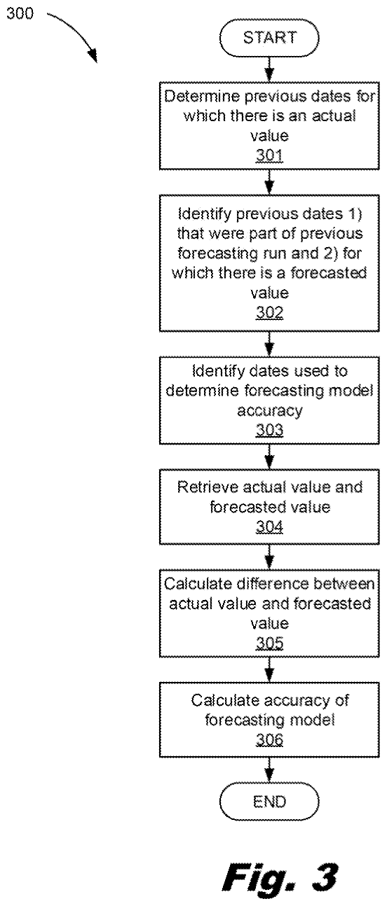

FIG. 3 is a flowchart of a method (300) for selecting dates to determine forecasting model accuracy, according to an example of the principles described herein. According to the method (300), previous dates for which there is an actual value associated with an event are determined (block 301). From those previous dates, previous dates are identified (block 302) 1) that were part of a previous forecasting run and 2) for which there is a forecasted value available. These dates are identified (block 303) as dates used to determine the accuracy of the forecasting model. These operations may be performed as discussed above in connection with FIG. 2.

Specifically, the system (FIG. 1, 100) identifies a pattern between the current run date and those previous dates for which there is a previously forecasted value available. The pattern may be determined based on the following relationship.

V_{daysBefore}(x,n)=((f DIV 7)^{3/2})−(F*n MOD 7)
∀f:f=(7,30) and
∀n∈I; I=set of positive integers

In the above, x is a character value of either “w” or “m” where w indicates week and m indicates month. In the above, n stands for number of weeks or the number of months. MOD refers to the remainder after dividing n by 7. The output of the system (FIG. 1, 100) is an integer number representing a reverse day count from the current date, i.e., a backdate, indicating for each forecasting category, what backdate (from the current date) has a forecasted value. For example, on any given weekly forecasting job, the system (FIG. 1, 100) may identify the following backdates for each forecasting category. For a 7^{th} day forecast category, 1 day before the current run date has a forecasted value. For a 30^{th} day forecast category, 6 days before the current run date has a forecasted value. For a 60^{th} day forecast category, 4 days before the current run date has a forecasted value. For a 90^{th} day forecast category, 2 days before the current run date has a forecasted value. For a 120^{th} day forecast category, 7 days before the current run date has a forecasted value. For a 150^{th} day forecast category, 5 days before the current run date has a forecasted value. For a 180^{th} day forecast category, 3 days before the current run date has a forecasted value.

Once the backdates are determined, the system (FIG. 1, 100) identifies specific dates associated with each backdate. Considering a current run date as 22 Feb. 2020 and the backdates calculated above, previous forecasted dates are fetched for the various forecast categories like 7th, 30th, 60th, 90th, 180th day categories.

For 7th day previous forecasted date, the previous date=run date−days before run date for 7th day. Using the above determined pattern, this is 22 Feb. 2020−1 day, or 21 Feb. 2020. For 30th day previous forecasted date, the previous date=run date−days before run date for 30th day. Using the above determined pattern, this is 22 Feb. 2020−6 days, or 16 Feb. 2020. For 60th day previous forecasted date, the previous date=run date−days before run date for 60th day. Using the above determined pattern, this is 22 Feb. 2020−4 days, or 18 Feb. 2020. For 90th day Previous forecasted date, the previous date=run date−days before run ate for 90^{th} day. Using the above determined pattern, this is 22 Feb. 2020−2 days, or 20 Feb. 2020. For 120th day previous forecasted date, the previous date=run date−days before run date for 120th day. Using the above determined pattern, this is 22 Feb. 2020−7 days, or 15 Feb. 2020. For 150th day previous forecasted date, the previous date=run date−days before run date for 150th day. Using the above determined pattern, this is 22 Feb. 2020−5 days, or 17 Feb. 2020. For 180th day previous forecasted date, the previous date run date−days before run date for 180th day. Using the above determined pattern, this is 22 Feb. 2020−3 days, or 19 Feb. 2020.

Accordingly, using the above determined relationship, the system (FIG. 1, 100) may determine for which previous dates there is a forecasted value, Using any, or all, of these dates, the forecasting model accuracy may be determined and updated as desired. While FIG. 3 depicts an example with particular frequencies and categories, the system (FIG. 1, 100) may determine previous dates based on any inserted frequency and category.

Once these dates are determined, the system (FIG. 1, 100) may retrieve (block 304) actual values and forecasted values associated with the previous date for which both values are available. In some examples, this may include identifying the previous run associated with the previous date, that is the date when the forecasting job was run which resulted in a forecasted value, and extracting the forecasted value from an entry in the database (FIG. 1, 102) associated with the previous run date. For example, if Feb. 15, 2020 is a date identified as having a forecasted value, it may be determined that a job run on Aug. 15, 2019 resulted in the forecast of Feb. 15, 2020. Accordingly, the system (FIG. 1, 100) may consult the database entry on Aug. 15, 2019 to identify the forecasted value on Feb. 15, 2020.

In another example, this may include identifying a forecasting category associated with the previous date, and extracting the forecasted value from an entry in the database (FIG. 1, 102) associated with the category. For example, if Feb. 15, 2020 is a date identified as having a forecasted value, it may be determined that this date was generated as part of a previously run 7^{th}-day forecast. Accordingly, the system (FIG. 1, 100) may consult the database entry for 7^{th}-day forecasts to identify the forecasted value on Feb. 15, 2020. As yet another example, the system (FIG. 1, 100) may simply scan the database (FIG. 1, 102) for an entry associated with Feb. 15, 2020 and extract the value.

In other words, upon deriving the previous dates for which a forecasted and actual value exist, the following two values are fetched: forecasted value for the previous dates and actual value for the previous dates. After the forecasted value and actual value is fetched from the historical data, the deviation (delta) and accuracy are calculated. That is, the method (300) may further include calculating (block 305) a difference between the actual value and the forecasted value. In another example, the method (300) may include calculating (block 306) an accuracy of the forecasting model by dividing the difference determined above, by the actual value.

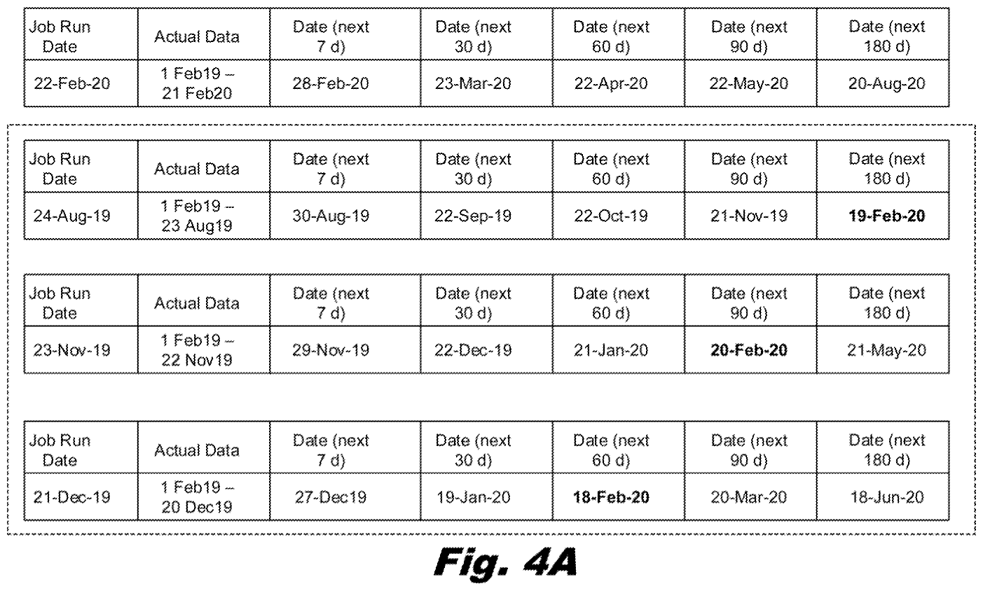

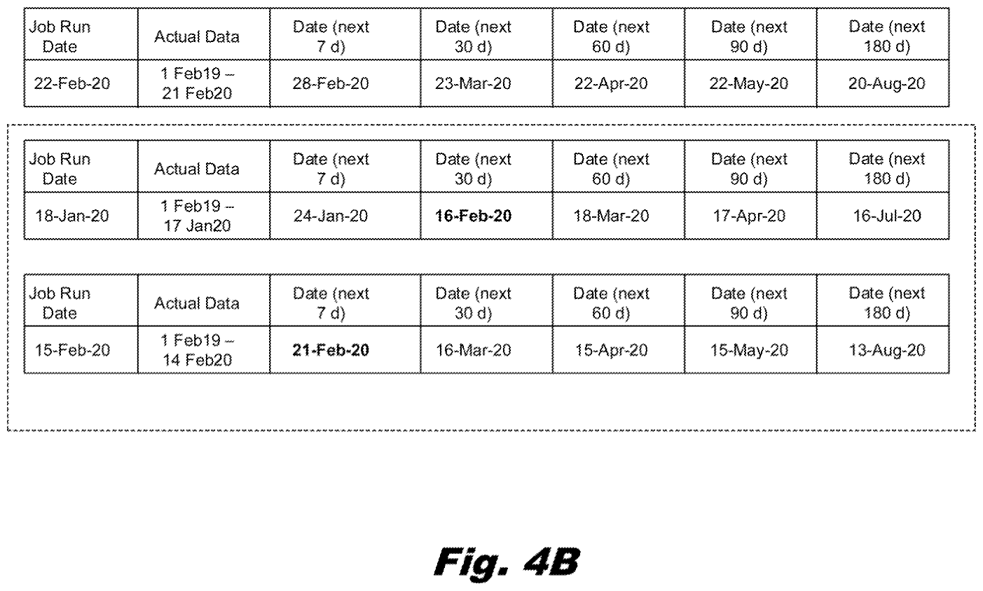

FIGS. 4A and 4B depicts various forecasting runs used to select dates to determine forecasting model accuracy, according to an example of the principles described herein. Specifically, FIG. 4A depicts one current run date, e.g., 22 Feb. 2020, along with the dates for which there is actual data, i.e., 1 Feb. 2019-21 Feb. 2020, as well as forecast dates. As described above, the system (FIG. 1, 100) may determine which previous runs (outlined in dashed box) forecasted events for dates that fall between the current run date, 22 Feb. 2020 and a previously run rate, which in the example depicted in FIGS. 4A and 4B is a weekly forecast such that the previous run date would be 15 Feb. 2020. As described above, the system (FIG. 1, 100) identifies 19 Feb. 2020, 20 Feb. 2020, 18 Feb. 2020, 16 Feb. 2020, and 21 Feb. 2020 as date for which there is forecasted data available and by which forecasting model accuracy is determined.

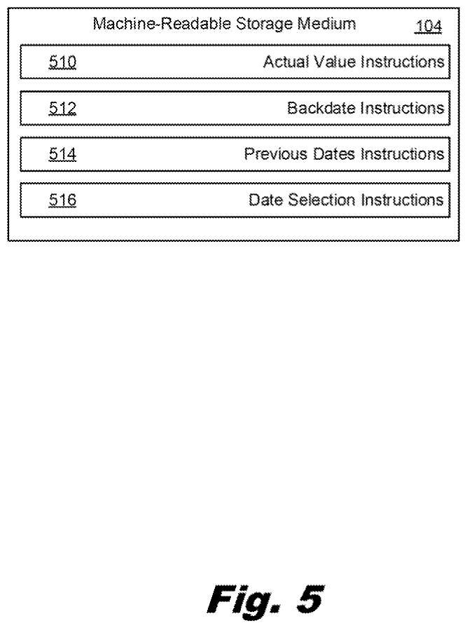

FIG. 5 depicts a non-transitory machine-readable storage medium (510) for selecting dates to determine forecasting model accuracy, according to an example of the principles described herein. To achieve its desired functionality, the system (FIG. 1, 100) includes various hardware components Specifically, the system (FIG. 1, 100) includes a processor (FIG. 1, 108) and a machine-readable storage medium (104). The machine-readable storage medium (104) is communicatively coupled to the processor. The machine-readable storage medium (104) includes a number of instructions (510, 512, 514, 516) for performing a designated function. In some examples, the instructions may be machine code and/or script code.

The machine-readable storage medium (104) causes the processor to execute the designated function of the instructions (510, 512, 514, 516). The machine-readable storage medium (104) can store data, programs, instructions, or any other-machine-readable data that can be utilized to operate the system (FIG. 1, 100). Machine-readable storage medium (104) can store machine readable instructions that the processor of the system (FIG. 1, 100) can process, or execute. The machine-readable storage medium (104) can be an electronic, magnetic, optical, or other physical storage device that contains or stores executable instructions. Machine-readable storage medium (104) may be, for example, Random-Access Memory (RAM), an Electrically Erasable Programmable Read-Only Memory (EEPROM), a storage device, an optical disc, etc. The machine-readable storage medium (104) may be a non-transitory machine-readable storage medium (718).

Referring to FIG. 5, actual event data dates instructions (510), when executed by the processor (FIG. 1, 108), cause the processor (FIG. 1, 108) to, determine, from a current date, previous dates for which there is an actual value of an event. Backdate instructions (512), when executed by the processor, cause the processor to, identify, as a backdate from the current data and based on a forecasting frequency, backdates 1) that were part of a previous forecasting run and 2) for which there is a forecasted value for the event. Previous dates instructions (514), when executed by the processor, cause the processor to, identify, based on the current date and backdate, previous dates for which there is both a forecasted value and an actual value. Date selection instructions (516), when executed by the processor, also cause the processor to, identify those previous dates for which there is both a forecasted value and an actual value as dates by which forecasting model accuracy is to be determined.

In summary, using such a system, method, and machine-readable storage medium may, for example, 1) accurately determine which dates and associated values may be used to determine an accuracy of a forecasting model; 2) provide for the reusability of the method to derive exact previous forecast dates for the calculation of deviation and accuracy in any forecasting model; 3) eliminate manual data analysis; and 4) be highly customizable. However, it is contemplated that the devices disclosed herein may address other matters and deficiencies in a number of technical areas, for example.

What is claimed is:

1. A system, comprising
a database comprising:
forecasted values of an event indexed by date; and
actual values of the event indexed by date;
a non-transitory machine-readable storage medium to store instructions;
and
a processor to execute the instructions, the instructions to cause the processor to:
determine, from a current date and based on a forecasting frequency and forecasting category for forecasted values, previous dates for which there is both a forecasted value and an actual value; and
identify those previous dates for which there is both an actual value and a forecasted value as dates by which a forecasting model accuracy is to be determined.

2. The system of claim 1, wherein the instructions are to further cause the processor to update the forecasting model based on a deviation between the actual value and the forecasted value for a date.

3. The system of claim 1, wherein forecasted values are further indexed by forecasting category.

4. The system of claim 1, wherein the forecasting frequency is received via user input.

5. A method, comprising:
determining, from a current date, previous dates for which the actual value of an event;
identifying, based on a forecasting frequency, which previous dates:
were part of a previous forecasting run; and
for which there is a forecasted value for the event:
identifying those previous dates for which there is an actual value and a forecasted value as dates by which forecasting model accuracy is to be determined.

6. The method of claim 5, wherein identifying the previous dates comprises:
identifying the previous dates as backdates; and
determining the previous dates based on the current date and the backdates.

7. The method of claim 6, further comprising retrieving the actual value and the forecasted value associated with the previous date for which both values are available.

8. The method of claim 7, further comprising calculating a difference between the actual value and the forecasted value.

9. The method of claim 8, further comprising calculating an accuracy of the forecasting model by dividing the difference by the actual value.

10. The method of claim 6, further comprising:
identifying the previous run date associated with the previous date; and
extracting the forecasted value from an entry in a database associated with the previous run date.

11. The method of claim 6, further comprising:
identifying a forecasting category associated with the previous date; and
extracting the forecasted value from an entry in a database associated with the forecasting category.

12. A non-transitory machine-readable storage medium encoded with instructions executable by a processor, the machine-readable storage medium comprising instructions to, when executed by the processor, cause the processor to:
determine, from a current date, previous dates for which there is actual value of an event;
identifying, as a backdate from the current date and based on a forecasting frequency, backdates:
that were part of a previous forecasting run; and
for which there is forecasted value of the event:
identifying, based on the current date and the backdates; previous dates for which there is both a forecasted value and an actual value; and
identifying those previous dates for which there is both a forecasted value and an actual value as dates by which forecasting model accuracy is to be determined.

13. The non-transitory machine-readable storage medium of claim 12, wherein the instructions are to, when executed by the processor, cause the processor to identify a forecasting category for the previous data.

14. The non-transitory machine-readable storage medium of claim 13, wherein the forecasting category is selected from the group consisting of:
a 7-day forecasting category;
a 30-day forecasting category;
a 60-day forecasting category;
a 90-day forecasting category; and
a 180-day forecasting category.

15. The non-transitory machine-readable storage medium of claim 13, wherein the instructions are to, when executed by the processor, cause the processor to output an accuracy of the forecasting model based on differences between the forecasted value and the actual value.
